(19) United States
(12) Patent Application Publication
(10) Pub. No.: US 2016/0117164 A1
(43) Pub. Date: Apr. 28, 2016

(54) SYSTEM AND METHOD FOR CUSTOMIZING MOBILE TECHNOLOGY PLATFORMS RESPECTIVE OF PERSONAS

(71) Applicant: Cellrox, Ltd., Tel Aviv (IL)

(72) Inventors: Oren LAADAN, New York, NY (US); Amir GOLDSTEIN, Tel Aviv (IL); Gilad BENJAMINI, Tel Aviv (IL)

(73) Assignee: CELLROX, LTD., Tel Aviv (IL)

(21) Appl. No.: 14/920,704

(22) Filed: Oct. 22, 2015

Related U.S. Application Data
(60) Provisional application No. 62/066,931, filed on Oct. 22, 2014.

(51) Int. Cl. G06F 9/445

(52) U.S. Cl. CPC G06F 8/65; G06F 9/445

(57) ABSTRACT

A mobile technology platform (MTP) and method for customizing a multiple-persona MTP are provided. The method includes detecting an activation of a persona on the MTP, wherein the persona is associated with an execution environment; identifying at least one operating condition related to execution of the persona on the MTP; determining at least one customization parameter based on the at least one operating condition; and customizing the execution environment based on the determined at least one customization parameter.

### CROSS-REFERENCE TO RELATED APPLICATIONS

This application claims the benefit of U.S. Provisional Application No. 62/066,931 filed on Oct. 22, 2014, the contents of which are hereby incorporated by reference.

### TECHNICAL FIELD

The present disclosure relates generally to multiple-persona mobile technology platforms, and more specifically for customizing mobile technology platforms respective of personas executed thereon.

### BACKGROUND

As mobile technology platforms accumulate new applications and operating systems become more advanced, carriers, publishers, developers, as well as original equipment manufacturers (OEMs) face difficulties in ensuring that the software programs provided to users of mobile technology platforms are kept updated. Further, OEMs face difficulties arising from a need to modify or add features to operating systems of mobile technology platforms. Over-the-air (OTA) updates are commonly used by developers and carriers to update versions of operating systems and application programs.

OTA updates typically include software program updates distributed over Wi-Fi or mobile broadband using a function built in the operating system of a device. OTA updating is a complex and expensive process wherein each version of an update must be certified, quality assured, and distributed to users. Typically, each update requires creating a new version of an operating system (or any other program code), pushing or otherwise delivering the entire new version to user devices, and installing the new version on user devices. As a result, issuing updates requires significant cost and computing resources. This resource usage limits the ability to add new functionality to mobile devices.

Additionally, installing a new version of an operating system may affect existing functions or applications installed in or utilized by a mobile device. As a result, applications and functions that operated as intended on one version of an operating system may suddenly cease functioning properly or entirely when a new version of the operating system is downloaded.

Operating systems typically affects usage of software and hardware resources of the computing device. As a result, operating systems control the access of applications running on the computing device to various software and/or hardware resources. Currently, a specific resource is either enabled or disabled to all applications installed on the computing device. That is, there is no way to allow only a specific application to access a resource. Moreover, applications (apps) developers are limited in their ability to adjust to operating system updates based on which changes are allowed by the operating system. As a result, the developers cannot customize applications without installing a new version of an application and/or operating system.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for customizing a multiple-persona mobile technology platform (MTP). The method comprises detecting an activation of a persona on the MTP, wherein the persona is associated with an execution environment; identifying at least one operating condition related to execution of the persona on the MTP; determining at least one customization parameter based on the at least one operating condition; and customizing the execution environment based on the determined at least one customization parameter.

The disclosed embodiments also include a multiple-persona mobile technology platform (MTP) for enabling execution of customized personas. The MTP comprises a processing unit; and a memory, the memory containing instructions that, when executed by the processing unit, configure the system to: detect an activation of a persona on the MTP, wherein the persona is associated with an execution environment; identify at least one operating condition related to execution of the persona on the MTP; determine at least one customization parameter based on the at least one operating condition; and customize the execution environment based on the determined at least one customization parameter.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system utilized to describe the various disclosed embodiments.

FIG. 2 is a flowchart illustrating a method for customizing a multiple-persona mobile technology platform according to an embodiment.

FIG. 3 is a diagram illustrating bind mounting in a multiple-persona mobile technology platform according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for enabling execution of customized personas on multiple-persona mobile technology platforms (MTPs). A persona activation on an MTP is detected. Persona activation may include any one of or any combination of the following states: installation, setup, instantiation, and startup of the persona. One or more operating conditions defining features related to execution of the persona are identified. In response to the detection of the persona activation, one or more customization parameters are determined for each feature defined in the persona conditions. Based on the determined customization parameters, an execution environment of the persona is customized. In an exemplary embodiment, customization may include bind mounting a sub-hierarchy of a file system to the determined customization parameters.

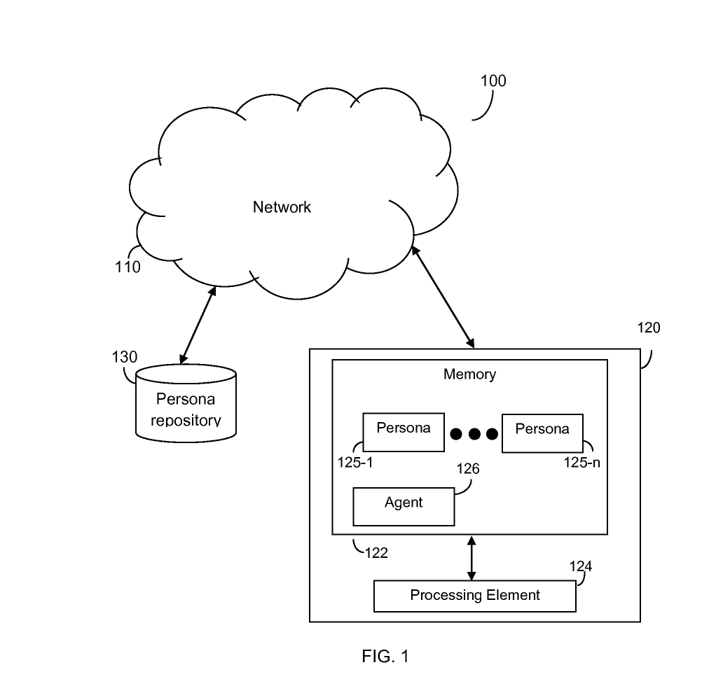

FIG. 1 is an exemplary and non-limiting schematic diagram 100 of a network system utilized to describe the various disclosed embodiments. The network system includes a network 110 communicatively connected to a multiple-persona mobile technology platform (MTP) 120 as well as to a persona repository 130. The network 110 may be, but is not limited to, a wireless, cellular or wired network, a local area network (LAN), a wide area network (WAN), a metro area network (MAN), the Internet, the worldwide web (WWW), similar networks, and any combination thereof. The MTP 120 may be, but is not limited to, a laptop computer, a tablet computer, a smartphone, a cellular phone, a notebook computer, a Smart television, an intra-vehicle infotainment (IVI) system, a wearable computing device, and the like.

The MTP 120 typically includes, but is not limited to, a processing unit 122 coupled to a memory unit 124, a plurality of personas 125-1 through 125-n (hereinafter referred to individually as a persona 125 and collectively as personas 125, merely for simplicity purposes), and an agent 126 installed therein. The memory of the MTP 120 further includes instructions, settings, rules, and configurations associated with each persona 125. The agent 126 may be, but is not limited to, a software code installed in the memory unit 124 and executed by the processing unit 122. Alternatively, a script that is natively supported by an operating system of the MTP 120 may be used instead of the agent 126. The agent 126 may be executable code that is associated with the memory 124 and executed by the processing unit 122. In further configurations, the agent 126 may be any service running outside of or inside of a persona.

The MTP 120 is configured to execute the personas 125. Each persona 125 corresponds to a role or identity assumable by a user of the MTP 120 and to a unique execution environment. Each execution environment may be, but is not limited to, a virtual execution environment. Exemplary and non-limiting execution environments include operating systems, sandboxes, user-space containers, and hypervisors. Each persona may further include a unique set of metadata associated thereto. In an embodiment, any or all of the personas may be extracted or downloaded from the persona repository 130 communicatively connected to the MTP 120 over the network 110.

In an embodiment, a persona is a user profile defined as part of an operating system supporting a multiple-user feature in the MTP 120. Such a user profile is maintained and monitored by the MTP's 120 operating system and allows the user to define, for each persona, a set of specific applications (apps), passwords, and other lock mechanisms associated with a specific user of the profile. For example, one user profile may be set for the owner of the MTP 120 where all applications are available and another user profile may be set for a child using the MTP 120 where only games may be available.

The persona repository 130 is a web source that hosts a plurality of personas available for download and/or execution on the MTP 120. Personas hosted in the persona repository 130 may be classified into different categories. Following are a few non-limiting examples for personas: personal, professional, financial, corporate, government, banking, digital wallet, privacy, and so on. The personas may be defined by users (e.g., owners of MTPs, an entity providing an MTP to its employee, and so on).

In certain embodiments, the persona repository 130 may also allow browsing through a plurality of personas, searching for personas, and checking for persona updates either implicitly or explicitly. Communications between the MTP 120 and the persona repository 130 may be over a hypertext transfer protocol (HTTP), a HTTP secure (HTTPS) protocol, or via other encrypted or unencrypted protocols.

As a non-limiting example, a cellular service provider (or an original equipment manufacturer) can construct a customized persona for testers, such as users or employers of the cellular service provider. The customized persona may be utilized by a tester at a location for testing and may include an execution environment that is tailored for testing purposes (i.e., disabling features that are not necessary for testing and/or enabling features that benefit testing). The special persona can be executed for various automated or remote controlled tests in a variety of environments (e.g., different geography, weather, etc.) for the MTP 120. Use of this customized persona does not affect the execution environments (e.g., the operating system) while executing other personas.

As another non-limiting example, a wife has a normally inactive persona on her device hosting the MTP 120 that replicates, in real-time, a main persona on a device hosting the MTP 120 of the wife's husband's MTP, and vice-versa. Thus, if one spouse's MTP is damaged, he or she may borrow the other spouse's device, switch to the normally inactive persona, and access his or her main persona thereon. The normally inactive persona may utilize an execution environment that operates differently from the main persona of the MTP. When the borrowing spouse ceases using the MTP of the lending spouse, the lending spouse may resume the normal execution environment of the main persona on the MTP.

In an embodiment, the agent 126 is configured to detect an activation of a persona on the MTP. The persona activation may be, but is not limited to, installation of the persona, setup of the persona, instantiation of the persona, startup of the persona, or any combination thereof.

The agent 126 is further configured to identify one or more operating conditions defining features related to the execution of the persona. The operating conditions may be associated with the persona and/or with the MTP 120. Operating conditions include any feature that relates to the operation of a persona, content of a persona, and/or the MTP. In an embodiment, such conditions may include, but are not limited to, a policy of the persona, a type of the persona, an owner of the persona (e.g., a developer's persona version), a version of the persona, an operational mode of the persona, metadata associated with the persona, a time pointer associated with an execution of the persona, and so on. Operating conditions associated with the MTP 120 may be, but are not limited to a type of device on which the MTP 120 is executed, an operating system type, an operating system version, an environmental pointer (e.g., a location or a network), combinations thereof, and so on.

The agent 126 is configured to determine one or more customization parameters based on the identified operating conditions. The one or more customization parameters may be determined based on, e.g., predetermined parameters that, when applied in an execution environment, satisfy the identified operating conditions. A few examples are provided below.

Based on the determined customization parameters, the execution environment of the persona is customized. The customization enables the execution environment to satisfy all operating conditions for the persona. In an embodiment, the parameters and/or operation conditions that require customization for each persona may be configured by, but not limited to, information technology personnel, a security policy, a server external to the MTP 120, a user of the MTP 120, a policy of an operating system of the MTP 120, and so on.

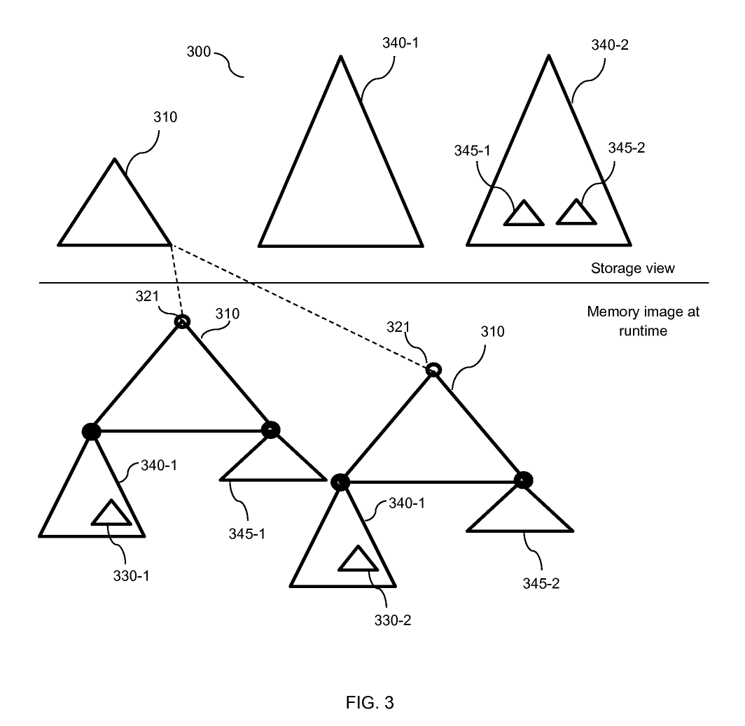

In one non-limiting embodiment, the customization is enabled by bind mounting the sub-hierarchies of a file system of the MTP 120 to the portions of the memory 124 containing the customization parameters. As a result, upon activation, relevant customization parameters may be accessed by any or all of the sub-hierarchies, thereby yielding a customized executing environment in accordance with the operating conditions of the persona. Typically, a file system is structured as a hierarchy, i.e., the first mount point. Thereafter, a sub-hierarchy of the overall file system hierarchy is mounted onto at least a second mount point in the hierarchy. The second mount point makes the sub-hierarchy visible and accessible through the at least a second mount point. It should be noted that either a sub-hierarchy or a particular file may be bind-mounted onto the second mount point. If a particular file is bind-mounted onto the second mound point, the file will be visible at each of the first and second mount points. Customizing an execution environment based on bind mounting is described further herein below with respect to FIG. 3.

In another non-limiting embodiment, the customization is using an overlay (or union) file system. According to this embodiment, when access is requested to a file, the operating system first looks for the file in secondary file system hierarchy, and, if the file is not found the secondary file system hierarchy, searches for the requested file in the base file system hierarchy. In a further embodiment, modifying a file of the base file system hierarchy includes creating a new copy of the file in the secondary file system hierarchy and modifying the created new copy of the file. Therefore, this overlaying allows customizing parameters (by modifying their respective files), by merely changing the file system hierarchy's view to the operating system. As such, no modification to the base file system is needed.

The customization of the execution environment is made with reference to a base setup of the MTP 120, a base configuration of the MTP 120, and/or a base structure of the MTP 120. As an example, a base execution environment of a persona may cause a performance including a standard Android open source platform's (AOSP's) behavior/setup, and customized execution environments may demonstrate features that deviate from that of the base execution environment.

Customized features may include, but are not limited to, appearance features, bundle features, setup features, and system features. Appearance features may include visual features presented to a user of the MTP 120 during execution of the persona such as, but not limited to, a theme, a style, a locale, fonts, icons, display defaults, and so on. A customized display default may include a customized resolution, font size, icon size, wallpaper of a home screen, icons to be displayed, and so on.

Bundle features may include custom application programs and/or content to be delivered to the persona during instantiation. Customization of bundle features may allow, e.g., custom content to be delivered to the MTP 120 in real-time, thereby ensuring that any such delivered content is up-to-date.

Setup features are features that contribute to configure settings of the persona during setup. Setup features may include, but are not limited to, device properties (e.g., a brand, model, and/or system), default settings (e.g., whether data roaming is enabled), selections of features and components (e.g., availability of near field communication and/or Bluetooth), and so on. The setup customizations may be provided by, for example, an original equipment manufacturer (OEM) or an original design manufacturer (ODM) associated with the MTP 120.

System features define permissions for access to hardware and/or software components of the MTP 120 during execution of the persona. Such permissions may indicate which components may be accessed and/or any restrictions or limitations placed upon such access.

Customizations may be modular and may combine unrelated sub-customizations (i.e., customization may include modifying any or all of: appearance features, bundle features, setup features, and system features at the respective appropriate stages of persona operation) in order to generate a desired result.

It should be noted that the processing unit 122 may comprise or be a component of a processor (not shown) or an array of processors coupled to the memory unit 124. The memory unit 124 contains instructions that can be executed by the processing unit 122. The instructions, when executed by the processing unit 122, cause the processing unit 122 to perform the various functions described herein. The one or more processors may be implemented with any combination of general-purpose microprocessors, multi-core processors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

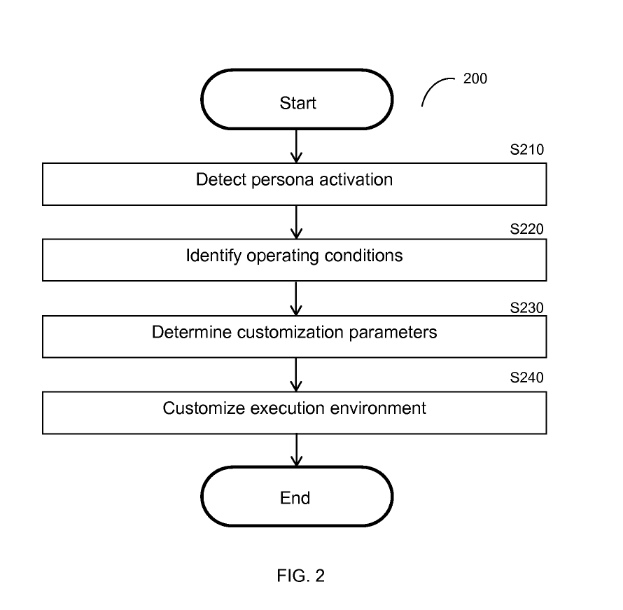

FIG. 2 is an exemplary and non-limiting flowchart 200 illustrating a method for customizing a mobile technology platform (MTP) respective of a persona according to an embodiment. In an embodiment, the method may be performed by an agent (e.g., the agent 126) installed on the MTP (e.g., the MTP 120).

In S210, activation of a persona on the MTP is detected. The persona activation may include, but is not limited to, installation of the persona, a stage of persona operation (e.g., setup of the persona, instantiation of the persona, startup of the persona, etc.), and so on.

Information regarding a persona to be installed may be retrieved from a persona repository (e.g., the persona repository 130) over a network (e.g., the network 110). The installation may include, but is not limited to, browsing a persona repository, searching for a particular persona in the persona repository, downloading a persona to the MTP, querying for a persona update, and so on.

In S220, one or more operating conditions related to the persona are identified. In an embodiment, the operating conditions are identified respective of the current activation state. That is, for example, different operating conditions may be identified for, e.g., installation as opposed to activation. As noted above, each operating condition defines features that may be associated with the persona and/or the MTP. Exemplary operating conditions are described further herein above with respect to FIG. 1.

In S230, customization parameters are determined for the execution environment based on the identified operating conditions. The customization parameters are determined such that customization based on the customization criteria will modify the execution environment to satisfy the identified operating conditions. The customization parameters may define, but are not limited to, appearance features, bundle features, setup features, system features, and combinations thereof.

In an exemplary embodiment, one or more operation conditions are mapped to one or more customization parameters that should be modified. For example, if the operation condition is a secured persona that limits any access to external peripherals, then the respective operation system's customization parameters disabling access to USB ports are identified. It should be noted that identifying such customization parameters further includes determining their appropriate values to satisfy the operation conditions.

In S240, an execution environment of the persona is customized based on the determined customization parameters. In an embodiment, the customization may include bind mounting one or more sub-hierarchies of a file system of the MTP such that the operating conditions are satisfied. Customizing the MTP based on bind mounting is described further herein below with respect to FIG. 3.

As a non-limiting example, startup of a work persona to be executed on the MTP is detected. Operating conditions related to execution of the work persona are identified. The operating conditions indicate that an MTP executing the work persona may not access public Wi-Fi networks. Based on the Wi-Fi restriction, customization parameters for preventing logging into a public Wi-Fi network via the system settings are determined. A sub-hierarchy of a file system of the MTP that is responsible for controlling network access is bind mounted to the determined customization parameters. Consequently, during execution of the work persona, a user of the MTP cannot access public Wi-Fi networks.

FIG. 3 is an exemplary and non-limiting diagram illustrating an image of the memory of an MTP (e.g., the MTP 120) prior to and during runtime according to an embodiment. A file system of the MTP includes a root 310, a system directory 340-1, and a data directory 340-2. Prior to runtime, all directories are saved in the storage with no specific association between them. This is illustrated as the storage view in FIG. 3.

Typically, the system directory 340-1 (“/system”) in the storage holds, among other things, sub-hierarchies (sub-directories) related to particular operating conditions. Such sub-hierarchies are usually read-only, thus can be served for instantiations of any persona. The storage directory 340-2 (“/data”) holds, among other things, sub-hierarchies (sub-directories) 345-1 and 345-2 related to operating conditions of personas. Thus, these sub-directories are read-write, and can be modified for each persona's data and setup. The sub-directories 345-1 and 345-2 include data related to personas P1 and P2, respectively. It should be noted that sub-directories holding the personas' data can be files and/or directories.

At runtime, a mounting of the filing system is performed, where two file system hierarchies are generated for personas P1 and P2, respectively. For the first hierarchy (of persona P1), the operating system mounts the system directory 340-1 and the data sub-directory 345-1 to appear under the root 310 as sub-directories. Similarly, for the second hierarchy (of persona P2), the operating system mounts the system directory 340-1 and the data sub-directory 345-2 to appear under the root 310 as sub-directories. The directory provided to the operating system is called the mount point. The mounting of the root directory is performed via a primary mount point 321.

This bind-mount and the two hierarchies allow for a complete separation of data between the two personas. However, it should be noted that two personas (P1 and P2) may have a shared data directory (not shown in FIG. 1). The data sub-directories 345-1 and 345-2 include, among other things, files containing customization parameters related to runtime features.

In addition, at runtime, sub-directories (or files) 330-1 and 330-2 including customization parameters of, for example, setup features of the personas P1 and P2, respectively, are mounted on sub-directories (or files) of the to the system directory 340-1 currently holding the parameters to be customized. As a result of the mounting or loading of the setup sub-directories, at runtime, the system directory 340-1 includes the customization parameters customized per each persona P1 and P2.

It should be noted that customization of only two personas through bind-mounting is illustrated merely for simplicity purposes and without any limitations on the disclosed embodiments. Other numbers of personas may be customized via bind-mounting without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for customizing a multiple-persona mobile technology platform (MTP), comprising:
detecting an activation of a persona on the MTP, wherein the persona is associated with an execution environment;
identifying at least one operating condition related to execution of the persona on the MTP;
determining at least one customization parameter based on the at least one operating condition; and
customizing the execution environment based on the determined at least one customization parameter.

2. The method of claim 1, wherein the persona is a user profile defined as part of an operating system supporting a multiple-user feature of the MTP.

3. The method of claim 1, wherein the persona is defined with a unique set of user preferences.

4. The method of claim 1, wherein the customization is made with reference to any of: a base setup of the MTP, a base configuration of the MTP, and a base structure of the MTP.

5. The method of claim 1, wherein the at least one operating condition defines at least one of: an appearance feature, a bundle feature, a setup feature, and a system feature.

6. The method of claim 1, wherein customizing the execution environment based on the determined at least one customization parameter further comprises:
bind mounting at least one sub-hierarchy of a file system of the MTP to at least one mount point.

7. The method of claim 1, wherein customizing the execution environment based the determined at least one customization parameter further comprises:
overlaying a secondary file system hierarchy over a base file system hierarchy of the MTP; and
customizing the execution environment based on the determined at least one customization parameter by modifying at least one file in the secondary file system hierarchy.

8. The method of claim 1, wherein the activation of the persona is detected based on any of: installation of the persona, setup of the persona, instantiation of the persona, and startup of the persona.

9. The method of claim 1, wherein each of the operating conditions is related to any of: operation of the persona, content of the persona, and the MTP.

10. The method of claim 1, further comprising:
retrieving the persona from a persona repository; and
activating the persona in the MTP.

11. The method of claim 10, wherein retrieving the persona from the persona repository further comprises at least one of: searching through the persona repository, downloading the persona, and retrieving an update to the persona.

12. The method of claim 1, wherein the at least one operating condition is configured by any of: information technology personnel, a security policy, a server external to the MTP, a user of the MTP, and a policy of an operating system of the MTP.

13. A non-transitory computer readable medium having stored thereon instructions for causing one or more processing units to execute the method according to claim 1.

14. A multiple-persona mobile technology platform (MTP) for enabling execution of customized personas, comprising:
a processing unit; and
a memory, the memory containing instructions that, when executed by the processing unit, configure the system to:
detect an activation of a persona on the MTP, wherein the persona is associated with an execution environment;
identify at least one operating condition related to execution of the persona on the MTP;
determine at least one customization parameter based on the at least one operating condition; and
customize the execution environment based on the determined at least one customization parameter.

15. The MTP of claim 14, wherein the persona is a user profile defined as part of an operating system supporting a multiple-user feature of the MTP.

16. The MTP of claim 14, wherein the persona is defined with a unique set of user preferences.

17. The MTP of claim 14, wherein the customization is made with reference to any of: a base setup of the MTP, a base configuration of the MTP, and a base structure of the MTP.

18. The MTP of claim 14, wherein the at least one operating condition defines at least one of: an appearance feature, a bundle feature, a setup feature, and a system feature.

19. The MTP of claim 14, wherein the MTP is further configured to:
bind mount at least one sub-hierarchy of a file system of the MTP to at least one mount point.

20. The MTP of claim 14, wherein the MTP is further configured to:
overlay a secondary file system hierarchy over a base file system hierarchy of the MTP; and
customize the execution environment based on the determined at least one customization parameter by modifying at least one file in the secondary file system hierarchy.

21. The MTP of claim 14, wherein the activation of the persona is detected based on any of: installation of the persona, setup of the persona, instantiation of the persona, and startup of the persona.

22. The MTP of claim 14, wherein each of the operating conditions is related to any of: operation of the persona, content of the persona, and the MTP.

23. The MTP of claim 14, wherein the MTP is further configured to:
retrieve the persona from a persona repository; and
activate the persona in the MTP.

24. The MTP of claim 23, the MTP is further configured to perform at least one of: search through the persona repository, download the persona, and retrieve an update to the persona.

25. The MTP of claim 14, wherein the at least one operating condition is configured by any of: information technology personnel, a security policy, a server external to the MTP, a user of the MTP, and a policy of an operating system of the MTP.
